(19) United States
(12) Patent Application Publication
(10) Pub. No.: US 2024/0409859 A1
(43) Pub. Date: Dec. 12, 2024

(54) LOW-ALCOHOL OR ALCOHOL-FREE BEVERAGE OBTAINED WITH MALTOSE-NEGATIVE YEAST AND SUBSEQUENT DEALCOHOLIZATION

(71) Applicant: Chr. Hansen A/S, Hoersholm (DK)

(72) Inventors: Simon Carlsen, Hoersholm (DK); Karsten Laurents, Hoersholm (DK); Sofie Saerens, Hoersholm (DK); Ad Van Etten, Hoersholm (DK)

(73) Assignee: Chr. Hansen A/S, Hoersholm (DK)

(21) Appl. No.: 18/688,273

(22) PCT Filed: Mar. 31, 2022
(86) PCT No.: PCT/EP2022/058531

§ 371 Date: Feb. 29, 2024

(30) Foreign Application Priority Data
Sep. 2, 2021 (EP) 21194486.3
Dec. 22, 2021 (EP) 21216958.5

(51) Int. Cl. C12C 12/04; C12C 12/00; C12H 3/02

(52) U.S. Cl. CPC C12C 12/04; C12C 12/006; C12H 3/02

(57) ABSTRACT

The invention relates to a method of producing a beverage comprising the steps of (a) fermenting a wort using a culture comprising a maltose-negative yeast strain to obtain a fermented beverage having an alcohol content of less than 1.00% v/v; and (b) subjecting the fermented beverage to a thermal dealcoholization step at a temperature between 2° and 80° C. to obtain the beverage.

### FIELD OF THE INVENTION

The invention relates to the production of a low-alcohol or alcohol-free beverage, such as a low-alcohol or alcohol-free beer. Specifically, the invention relates to a method for producing a low-alcohol or alcohol-free beverage with enhanced sensory profile, in particular enhanced levels of desirable fermentation-derived flavor and aroma, as well as a low-alcohol or alcohol-free beverage obtainable by the method.

### BACKGROUND OF THE INVENTION

Due to the increasing demand for healthier food and beverages, the reduction of ethanol in alcoholic beverages, especially beer and wine, is of considerable commercial interest. Specifically, alcohol-free beer as a malt-based, calorie-reduced refreshment with various nutrient-physiologically positive properties is no longer considered a niche product.

Various processes are known and already established for the production of light, low-alcohol, or alcohol-free beers. In general, these processes can be classified into two groups. On the one hand, there are physical processes in which ethanol is removed as selectively as possible from regular beer or another alcoholic beverage matrix such as wine or cider, mainly by thermal or membrane processes. On the other hand, there are methods summarized as biological methods, which are based on a restricted ethanol formation, such as use of a modified mashing process, use of a limited fermentation process or a limited yeast metabolism, known as stopped fermentation, or use of special yeasts.

However, compared to regular alcoholic beer, the above products differ markedly in their aroma profile (Müller et al., 2017). For instance, it was reported that early attempts of thermal dealcoholization by evaporation of ethanol resulted in a significant damage of beer taste (Branyik et al., 2012). Even nowadays vacuum evaporation techniques suffer from the limitations that they also remove to some extent other volatile components such as flavor and fragrance compounds and dissolved gases which are important in sensory characteristics rendering the final product flavor to be reduced extensively (Sohrabvandi et al., 2010; Mangindaan et al., 2018). Some thermal dealcoholization processes are able to reduce the alcohol content from a normal beer strength of about 5% v/v to less than 0.05% v/v. In some countries such an alcohol content allows for a desired declaration of “0.0% ABV” on the final products. However, in doing so, original aroma is removed from the product so that a new aroma profile has to be built up-either from external aroma packages, which adds extra costs and must be declared on the product label, or from a recovered part of the original liquid, so called “aroma water”. In the latter case, recovered aroma compounds that are returned into the product need not be declared on the label, but as they also contain some amount of alcohol, the alcohol content of the final product will increase again above e.g. 0.05% v/v. In other words, it is very challenging to provide a beer with an alcohol content of less than 0.05% v/v and at the same time without adding aroma).

In view of the above limitations, some authors considered dealcoholization employing membrane processes to be the spotlight for the future perspective and development (Mangindaan et al., 2018). In their view, the membrane processes demonstrate promising results for beverage dealcoholization while preserving the sensorial properties.

Moreover, some other authors focused on the use of non-conventional yeasts instead of removal of alcohol by physical methods like reverse osmosis or vacuum rectification. For example, use of new strains of Saccharomycodes ludwigii and Zygosaccharomyces rouxii to produce low-alcohol beer having an ethanol content of 0.5 to 1.2% v/v is reported (De Francesco et al., 2014). Likewise, Vastik et al. studied the use of non-Saccharomyces yeast strains Saccharomycodes ludwigii, Schizosaccharomyces pombe, Lachancea fermentati and Pichia angusta together with a hybrid yeast strain cross-bred between genetically modified Saccharomyces cerevisiae W303-1A G418R and Saccharomyces eubayanus as well as the parent yeasts of the hybrid for potential use for non-alcoholic beer production (Vastik et al., 2020). The use of Pichia kluyveri to make low-alcohol beer is known from e.g. WO 2014/135673. It is described that this yeast is capable of fermenting glucose only—while conventional beer yeasts are capable of fermenting glucose and maltose in beer wort. Recently, lorizzo et al. reported that some non-Saccharomyces yeasts have a specific enzymatic activity that can help to typify the taste and beer aroma (lorizzo et al., 2021).

Jiang et al. describe the production of low-alcohol beer having an alcohol content of less than 0.5% v/v by combination of a limited fermentation process using Saccharomycodes ludwigii and a subsequent dealcoholization step using vacuum distillation at 64 to 68° C. to further reduce the alcohol content (Jiang et al., 2017). However, a number of drawbacks is associated with this process. In the first step, a limited fermentation is required by modulating the profile of wort sugars in a multistep infusion mash, i.e. reducing the level of fermentable sugar in the wort, and cooling of the fermentation tank. Furthermore, the concentrated extract obtained at the end of the distillation step needs to be diluted with deoxygenated water at a ratio of the deoxygenated water and the concentrated extract of 17.5:1. Moreover, to improve the organoleptic properties, regularly maturated beer having an alcohol content of 4.5% v/v is added at a level of 9% to make the final product with an alcohol concentration of less than 0.5% v/v.

Thus, there is still a need for an improved method for producing a low-alcohol or alcohol-free beverage, in particular a low-alcohol or alcohol-free beer. Specifically, it would be desirable to provide a fermented beer having a low alcohol content and at the same time superior organoleptic or sensory properties, such as a superior aroma or flavor profile. More specifically, it would be desirable to provide a fermented beer having a low alcohol content, in particular an alcohol content of less than 0.05% v/v, i.e. an alcohol content which allows avoiding any declaration of alcohol on the product label, with superior organoleptic or sensory properties. At the same time, the addition of external aroma compounds should be dispensed with to avoid the need of a corresponding declaration on the product label. Furthermore, it would be desirable to provide this beverage by a simple process, in particular without the need of diluting the dealcoholized beverage with substantial amounts of water and/or without the need of adding e.g. regular beer to the fermented beverage. In addition, it would be desirable that the method for producing the beverage does not require high amounts of energy.

### SUMMARY OF THE INVENTION

This problem is now solved by a method for producing a beverage comprising the steps of:
(a) fermenting a wort using a culture comprising a maltose-negative yeast strain to obtain a fermented beverage having an alcohol content of less than 1.00% v/v; and
(b) subjecting the fermented beverage to a thermal dealcoholization step at a temperature between 20° C. and 80° C. to obtain the beverage.

The beverage is preferably hopped beer.

The present inventors surprisingly found that the combination of steps (a) and (b) results in a beverage having a very low alcohol content, in particular less than 0.05% v/v of alcohol (see e.g. Table 4, Sample 2; Table 6, Sample 6) and at the same time having superior organoleptic and sensory properties (see e.g. Table 5, Sample 2; Table 7, Sample 6).

In step (a), a beverage with a full and complex aroma profile is provided. Since the aroma is produced by a yeast, the beverage does not require a declaration of added aroma on the label. Due to the use of a maltose-negative yeast, the alcohol content of this beverage is lower compared to e.g. regular beer. However, it has an alcohol content of more than 0.05% v/v and would, therefore, not have a desired “0.0% ABV” declaration in many countries.

To obtain an alcohol content of less than 0.05% v/v this fermented beverage is passed to a thermal dealcoholization unit in step (b). It was found that due to the low alcohol content of the fermented beverage obtained in step (a) (less than 1.00% v/v compared to about 5% v/v in case of regular beer fermented with saccharomyces yeast), the alcohol concentration in the vapor phase of the dealcoholization unit is also much lower and, therefore, it is surprisingly possible to condense and return a rather high fraction of the condensed vapor phase, and thereby keeping all or most of the original aroma compounds in the product without causing the final alcohol concentration to increase above the 0.05% v/v limit. Consequently, it is possible that the final product is characterized by both a very low alcohol content of e.g. less than 0.05% v/v and the lack of a declaration of addition of external aroma. At the same time, the final product is surprisingly characterized by excellent sensory and organoleptic properties, in particular an excellent aroma and flavor.

Moreover, it was found that due to the low alcohol content of the fermented beverage obtained in step (a) the dealcoholization in step (b) can be carried out at rather mild conditions which require less energy in order to separate alcohol from the product.

The present invention further provides a beverage obtainable by the above method according to the invention.

Moreover, the present invention also relates to the use of a maltose-negative yeast strain for producing a beverage which includes the steps of:
(a) fermenting a wort using a culture comprising the maltose-negative yeast strain to obtain a fermented beverage having an alcohol content of less than 1.00% v/v; and
(b) subjecting the fermented beverage to a thermal dealcoholization step at a temperature between 20° C. and 80° C. to obtain the beverage.

### DETAILED DISCLOSURE OF THE INVENTION

In a first aspect, the present invention provides a method for producing a beverage. Specifically, a method for producing a low-alcohol beverage, preferably an alcohol-free beverage or a non-alcoholic beverage is provided.

The term “low-alcohol beverage” herein is defined as a liquid for drinking with an alcohol content of more than 0.5% v/v and no more than 1.0 vol.-%.

The term “alcohol-free beverage” herein is defined as a liquid for drinking with an alcohol content of no more than 0.5% v/v.

The term “non-alcoholic beverage” herein is defined as a liquid for drinking with an alcohol content of less than 0.05% v/v.

Accordingly, the beverage provided by the method according to the invention is characterized by an alcohol content of less than 1.0% v/v, preferably less than 0.5% v/v like less than 0.1% v/v, and more preferably less than 0.05% v/v, like 0.000 to 0.030% % v/v or 0.000 to 0.020% v/v or 0.000 to 0.010% v/v.

The beverage can be any beverage obtainable by fermentation of a wort, including wort-based beverages like beer. Most preferably, the beverage is hopped beer, including wheat beer and lager.

The term “fermentation” herein refers to a metabolic process that includes chemical changes in the wort substrate through the action of the culture comprising the maltose-negative yeast. This includes aerobic and anaerobic processes.

The term “wort” herein has the conventional meaning in the art and refers to the sugary liquid extracted from the mashing process of beer brewing. According to the present invention, any wort can be used which is capable of being metabolized by a maltose-negative yeast strain. In particular, any wort can be used which comprises monosaccharides that can be fermented. The wort may have a conventional composition and no modulation of the sugar profile is required. This is advantageous since no modified mashing process is required.

In addition, it is preferred that in step (a) the wort is fully fermented, i.e. it is preferred that essentially all monosaccharides contained in the wort are utilized by the yeast. Thus, it is preferred that no limited or arrested fermentation takes place which would require additional steps, such as cooling of the fermentation mixture.

The term “maltose-negative yeast strain” herein is defined as a yeast strain that does not ferment maltose, the most abundant sugar in conventional wort, to ethanol.

In one preferred embodiment, the maltose-negative yeast strain is a sucrose-negative yeast strain, i.e. a yeast strain that does not metabolize sucrose. In one embodiment, the maltose-negative yeast strain is Saccharomyces spp. In another embodiment, the maltose-negative yeast strain is a non-saccharomyces yeast.

Furthermore, it is particularly preferred that the maltose-negative yeast strain is capable of fermenting monosaccharides, such as glucose and fructose, only. Monosaccharides amount to a small fraction, such as 20%, 10% or less, of the sugars contained in conventional wort. Accordingly, such a yeast fermenting only monosaccharides results in a fermented beverage with a low or very low alcohol content.

In one preferred embodiment of the present invention, the maltose-negative yeast strain is Pichia spp., Zygosaccharomyces spp., Torulaspora spp., Candida spp., Zygosaccharomyces spp., Hanseniaspora spp., Kazachstania spp., Cyberlindnera spp., Trigonopsis spp., Saccharomycodes spp.

In a preferred embodiment of the present invention, the maltose-negative yeast strain is selected from the group consisting of strains of Pichia kluyveri, Pichia fermentans, Zygosaccharomyces lentus, Torulaspora delbrueckii, Candida zemplinina, Zygosaccharomyces rouxii, Hanseniaspora valbyensis, Hanseniaspora vineae, Zygosaccharomyces bailii, Zygosaccharomyces kombuchaensis, Kazachstania servazzii. Cyberlindnera mrakii, Cyberlindnera saturnus, Cyberlindnera misumaiensis, Trigonopsis cantarellii, Saccharomyces cerevisiae, Saccharomycodes ludwigii and mixtures thereof.

Thus, in a preferred embodiment, the present application provides a method of producing a wort-based beverage comprising the steps of:
(a) fermenting a wort using a culture comprising a non-saccharomyces maltose-negative yeast strain to obtain a fermented beverage having an alcohol content of less than 1.00% v/v; and
(b) subjecting the fermented beverage to a thermal dealcoholization step at a temperature between 20 to 80° C. to obtain the beverage.

It is particularly preferred that the maltose-negative yeast strain is a Pichia kluyveri strain. Strains of Pichia kluyveri have been found to produce beer with a low or very low alcohol content. At the same time strains of Pichia kluyveri have been found to have a very strong secondary metabolism resulting in a full and complex aroma profile of the obtained beer. Preferably, the Pichia kluyveri strain is selected from the group consisting of Pichia kluyveri DSM 28484, Pichia kluyveri PK-KR1 (JT1.28), Pichia kluyveri PK-KR2 (JT3.71), WLP605, and mixtures thereof.

In one preferred embodiment, the present invention also provides uses of a non-saccharomyces maltose-negative yeast strain for producing a beverage which includes the steps of:
(a) fermenting a wort using a culture comprising the maltose-negative yeast strain to obtain a fermented beverage having an alcohol content of less than 1.00% v/v; and
(b) subjecting the fermented beverage to a thermal dealcoholization step at a temperature between 20 to 80° C. to obtain the beverage.

In one preferred embodiment of the present invention, the maltose-negative yeast strain is Pichia spp., Zygosaccharomyces spp., Torulaspora spp., Candida spp., Zygosaccharomyces spp., Hanseniaspora spp., Kazachstania spp., Cyberlindnera spp., Trigonopsis spp., Saccharomycodes spp.

In a preferred embodiment of the present invention, the maltose-negative yeast strain is selected from the group consisting of strains of Pichia kluyveri, Pichia fermentans, Zygosaccharomyces lentus, Torulaspora delbrueckii, Candida zemplinina, Zygosaccharomyces rouxii, Hanseniaspora valbyensis, Hanseniaspora vineae, Zygosaccharomyces bailii, Zygosaccharomyces kombuchaensis, Kazachstania servazzii. Cyberlindnera mrakii, Cyberlindnera saturnus, Cyberlindnera misumaiensis, Trigonopsis cantarellii, Saccharomycodes ludwigii and mixtures thereof.

In view of the use of a maltose-negative yeast strain, the fermented beverage obtained in step (a) is characterized by a low alcohol content of less than 1.00% v/v. Preferably, the alcohol content of the fermented beverage obtained in step (a) is less than 0.8% v/v, preferably less than 0.6% v/v, more preferably less than 0.5% v/v or less than 0.4% v/v, like 0.2 to 0.3% v/v.

As explained above, it has surprisingly been found that such a low alcohol content of the fermented beverage is advantageous with respect to the subsequent dealcoholization step. Due to this low alcohol content of the fermented beverage, the alcohol concentration in the vapor phase of the thermal dealcoholization unit is also much lower and it has unexpectedly been found that for this reason it is possible to condense and return a rather high fraction of the vapor phase, so that all or most of the original aroma compounds can be kept in the liquid without causing the final alcohol concentration to increase above a 0.05% v/v limit.

In step (b), the fermented beverage obtained in step (a) is subjected to a thermal dealcoholization step to reduce the alcohol content of the beverage. Thermal dealcoholization steps are widely known in the art (see e.g. (Müller et al., 2017; Branyik et al., 2012). In general, the fermented beverage is separated into two fractions: a dealcoholized (alcohol-reduced) liquid phase and an alcohol containing (alcohol enriched) vapor phase. The separation is based on different volatilities of water and ethanol and, therefore, on evaporation of ethanol.

The thermal dealcoholization in step (b) is performed at a temperature of 20 to 80° C., preferably 20 to 70° C., preferably 20 to 60° C., like 20 to 50° C., more preferably 20 to 40° C., and most preferably 25 to 35° C. It has unexpectedly been found that a thermal dealcoholization at such low temperatures provides a beverage with a low alcohol content and at the same time superior organoleptic or sensory properties. In view of the low alcohol content of the fermented beverage obtained in step (a) and, therefore, the low alcohol concentration in the vapor phase of the dealcoholization unit in step (b), it is possible to condense and return a high fraction of the vapor phase, and thereby keeping all or most of the original aroma compounds in the liquid without causing the final alcohol concentration to substantially increase. Likewise, by applying such low temperatures thermal stress is prevented so that the thermal degradation of aroma compounds is avoided, and the process consumes less energy.

The thermal dealcoholization step can include distillation, rectification, vacuum rectification, stripping processes and any other steps which include separation of ethanol from the fermented beverage on the basis of the lower boiling point of ethanol compared to water. The thermal dealcoholization in step (b) can, for example, be performed in a vacuum rectification column, a thin film evaporator, a stripping column or a spinning cone column.

In addition, it is preferred that the thermal dealcoholization in step (b) is performed at a pressure of less than 40 kPa, preferably less than 20 kPa, more preferably less than 10 kPa, such as 1 to 5 kPa.

It is particularly preferred that the thermal dealcoholization in step (b) is vacuum stripping or vacuum rectification. Preferably, the vacuum rectification is performed in a vessel having a first end and a second end, wherein the fermented beverage obtained in step (a) is fed into the vessel in form of a liquid at the first end and a vapor stream is fed into the vessel at the second end, wherein the vapor flows through the vessel in countercurrent to the liquid fermented beverage and the vapor contacts the fermented beverage. Preferably, the vessel is a rectification column in which pre-heated fermented beverage of step (a) is fed into the top end of the column and flows down at a temperature between 20 to 80° C., preferably 20 to 60° C., like 20 to 50° C., more preferably 20 to 40° C., and most preferably 25 to 35° C. In counterflow the liquid contacts rising vapors, generated from low-alcohol or alcohol-free beverage in an evaporator, which brings about the selective separation of alcohol from the beverage. The rectification column is typically a packed-bed column to provide several successive cycles of evaporation and condensation.

In case of vacuum rectification, it is also preferred that the thermal dealcoholization in step (b) is performed at a vapor flow rate of 5 to 50 kg·h⁻¹, preferably 15 to 45 kg·h⁻¹, more preferably 20 to 45 kg·h⁻¹, such as 25 to 40 kg·h⁻¹ or 30 to 40 kg·h⁻¹. Moreover, in case of vacuum rectification, it is preferred that the thermal dealcoholization in step (b) is performed at a vapor back-pressure of 50 to 350 kPa, preferably 200 to 350 kPa, more preferably 250 to 350 kPa.

The combination of using a maltose-negative yeast strain to provide a fermented beer with a low alcohol content and using vacuum rectification as dealcoholization method is particularly advantageous. Compared to the dealcoholization of regular lager beer having an alcohol content of 4.9% v/v, the dealcoholization of mother beer obtained with a maltose-negative yeast strain and having an alcohol content of less than 1.00% v/v results in a decrease in vapor flow, back-pressure, vacuum and dealcoholization temperature. Furthermore, the desired alcohol content is reached faster, less malt and less fermentation cooling are required. More specifically, a corresponding comparison resulted in the following benefits of the method according to the invention:
The measured vapor flow was 32.89% lower.
The back pressure was 6.94% lower.
The vacuum was 26.10% lower.
The average rectification temperature was 28.83° C. which was 13.97° C. lower.
The desired alcohol content (<0.05% v/v) was reached 5 times faster.
About 60% less malt was needed.
No cooling to stop fermentation was required.

Optionally, the fermented beverage obtained in step (a) can be subjected to one or more additional steps prior to the thermal dealcoholization step. For instance, the fermented beverage obtained in step (a) can be filtered or centrifuged to clarify the beer, for example to remove unwanted substances such as yeast cells or protein aggregates, if preferred.

Furthermore, the fermented beverage obtained in step (a) can be degassed prior to dealcoholization to remove CO₂ and prevent foaming in the subsequent thermal step (b).

Conventional thermal dealcoholization methods typically include the step of recovering aroma components. These aroma components can be recovered from a decarbonization step, which is typically performed directly prior to thermal dealcoholization by withdrawing CO₂ and also a certain amount of volatile aromatics, and/or from non-condensable gases from the condenser of the dealcoholization unit. The aroma components are typically recovered by dissolving them in degassed brewing water to form an aqueous flavor concentrate (so-called aroma water), which allows a re-blend into the low-alcohol or alcohol-free beer within the scope of e.g. the German purity law. Moreover, conventional thermal dealcoholization methods typically include the step of diluting the resulting low-alcohol or alcohol-free beer with water or regular beer. While the addition of water serves to compensate for the loss of water during the thermal dealcoholization-especially at higher temperatures—the addition of regular beer aims at improving sensory or organoleptic properties.

It has been found that according to the method of the present invention neither such a blending with aroma water nor such a dilution with water nor such addition of regular beer is required. Hence these blending, dilution and addition steps may be avoided.

In some embodiments less than 20% v/v of aroma water, preferably less than 15% v/v of aroma water, more preferably less than 10% v/v of aroma water and most preferably less than 5% v/v of aroma water is added to the beverage after the thermal dealcoholization step (b), wherein the % v/v are based on the volume of the beverage obtained in step (b).

In some embodiments, less than 5% v/v of regular beer, preferably less than 4% v/v of regular beer, more preferably less than 3% v/v of regular beer and most preferably less than 2% v/v of regular beer is added to the beverage after the thermal dealcoholization step (b), wherein the % v/v are based on the volume of the beverage obtained in step (b).

In a second aspect, the present invention relates to a beverage obtainable by the method according to the first aspect. As described above, the method of the first aspect provides a beverage which is preferably a beer with a clean label, i.e. a beer with an alcohol content of less than 0.05% v/v and without addition of external aroma compounds, and with excellent sensory properties which are superior compared to those of beer obtained from the dealcoholization of regular beer fermented with saccharomyces yeast.

In a third aspect, the present invention is directed to the use a maltose-negative yeast strain for producing a beverage of the second aspect.

### FIGURES

FIG. 1 shows the alcohol content [vol.-% alc.] and extract [° P] measured during the thermal dealcoholization using vacuum rectification equipment (Sample 2).

FIG. 2 shows the pressure on the feed and on the loop side as well as the pressure over the membrane (=transmembrane pressure) [bar] during the dealcoholization using AromaPlus osmosis equipment (Sample 4)

FIG. 3 shows the alcohol content of the retentat and permeat [vol.-% alc.] and extract [° P] ] during the dealcoholization using AromaPlus osmosis equipment (Sample 4)

### EXAMPLES

### Example 1

1.1 Preparation of Low Alcoholic Mother Beer with Maltose-Negative Yeast

140 kg of malt (135 kg Pilsner malt+5 kg Carahell® malt) were mashed at 72° C. for 60 min in 490 L of water supplemented with 98 g of Brewtan B (a 100% natural, high molecular weight tannic acid extracted from renewable plant materials) and mashed out at 78° C. for 5 min. Subsequent to this mashing, the wort was separated from the grist by lautering and sparging. This resulted in about 900 L of wort in the wort kettle which were pH adjusted to pH 5.2 with lactic acid and then boiled for 60 min. 20 min prior to the end of this boiling, 73 g of Brewtan B were added. Furthermore, during the boiling, hops were added to provide bitterness, flavor and aroma. After boiling the wort was transferred to a whirlpool where lactic acid was added to adjust the pH to pH 4.2-4.4. Then, the wort was diluted to 7° Plato, cooled to 18° C., and aerated while being transferred to the fermentation tank. Defrosted Pichia kluyveri DSM 28484 was added directly to the tank and a circulation loop was started to mix the content of the fermentation tank. The fermentation process was continued until no further change in specific gravity was observed. The obtained mother beer was then cooled to 1-4° C., kept at this temperature and centrifuged prior to dealcoholization.

### 1.2 Dealcoholization

Starting from the mother beer obtained in Example 1 four different samples were obtained:

### Sample 1:

No further treatment, i.e. Sample 1 is identical to the mother beer of Example 1.1.

### Sample 2:

The mother beer of Example 1.1 was degassed to remove CO₂ and prevent formation of foam during subsequent the dealcoholization step. The degassed mother beer was then run through a vacuum rectification plant to remove alcohol contained in the mother beer and to obtain an alcohol-free beer (Sample 2). This was done by using a DeAlcoTec system from Centec GmbH which was operated in counter current mode. According to this process, the mother beer was heated and fed into a vacuum rectification column by dispersing the liquid mother beer at the top of the column. Exhaust vapor was fed into the bottom of the column and rose upwards inside the column in counter current to the falling warm liquid. Thereby, volatile alcohol was removed from the mother beer and the less volatile components fell to the column base and flowed into a falling film evaporator that generated the exhaust vapor. Densely packed, thin stainless steel sheets in the column maximized the transfer surface and the contact time between liquid product and exhaust vapors. The mother beer was fed to the system at a rate of 300 L/h. The key parameters of this dealcoholization process are summarized in Table 1 below.

TABLE 1

| Evaporation | Condenser | Condensate | Aroma water |
|---|---|---|---|
| temperature | temperature | return | flux |
| (° C.) | (° C.) | (L · h⁻¹) | (L · h⁻¹) |
| 34 | 10 | 60 | 60 |

During the process, vapor flow [kg/h], back pressure [bar], vacuum pressure [bar] and temperature [° C.] were monitored and summarized in Table 2 below.

TABLE 2

| t | Vapor flow | Back pressure | Vacuum | Temperature |
|---|---|---|---|---|
| (min) | (kg · h⁻¹) | (bar) | (bar) | (° C.) |
| 0 | 36.0 | 0.7 | 0.026 | 31.50 |
| 10 | 36.7 | 2.4 | 0.022 | 30.50 |
| 20 | 38.8 | 3.2 | 0.023 | 28.50 |
| 30 | 35.1 | 2.8 | 0.025 | 28.00 |
| 40 | 32.0 | 3.0 | 0.024 | 28.40 |
| 50 | 24.1 | 3.1 | 0.023 | 28.10 |
| 60 | 30.4 | 3.0 | 0.023 | 27.50 |
| 70 | 35.8 | 3.0 | 0.024 | 29.10 |
| 80 | 38.6 | 3.0 | 0.024 | 28.80 |
| 90 | 38.5 | 3.0 | 0.024 | 28.70 |
| 100 | 36.5 | 3.0 | 0.035 | 28.70 |
| 110 | 36.5 | 3.0 | 0.025 | 28.90 |
| 120 | 39.6 | 3.0 | 0.022 | 28.10 |

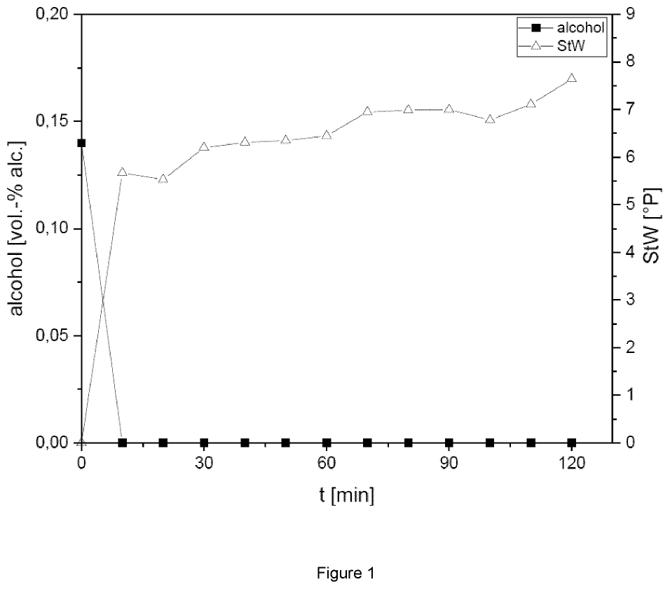

The alcohol content [vol.-% alc.] and extract [° P] were measured during dealcoholization and are shown in FIG. 1.

### Sample 3:

The alcohol-free beer obtained as Sample 2 was mixed with an aqueous phase of the aroma fraction captured by the DeAlcoTec system (known as aroma water). This was done based on the alcohol content of the aroma water and Sample 2. The amount of aroma water mixed with Sample 2 was adjusted to have an ethanol content of about 0.05% v/v.

### Sample 4:

The mother beer of Example 1.1 was subjected to a dealcoholization step using reverse osmosis. This was done by using AromaPlus equipment from GEA with up-concentrating to about 30% of original volume and subsequent back-dilution to about 50% of original volume. The key parameters used in the reverse osmosis process are shown in Table 3 below.

TABLE 3

| Concentration factor | Temperature | A loop and feed pressure |
|---|---|---|
| (% of Original Volume) | (° C.) | (bar) |
| 33 | 13° C. | 0.5 |

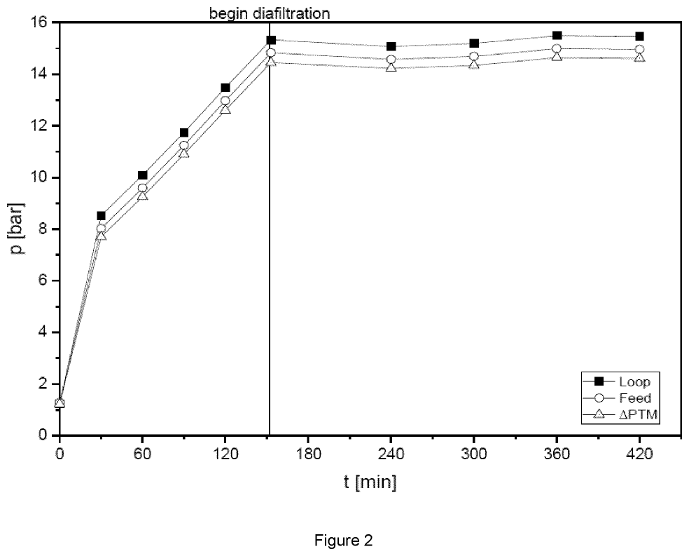

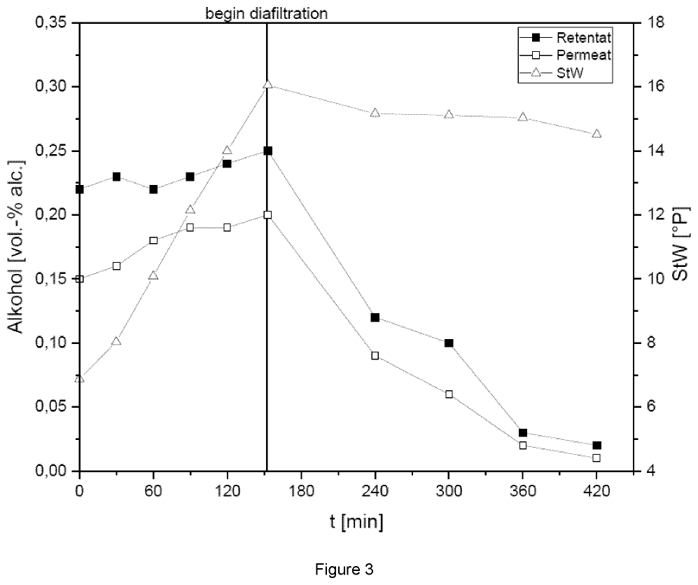

The pressure [bar] of the loop, the feed pressure and the transmembrane pressure, as well as the alcohol content of retentate and permeate [vol.-% alc.], and extract [° P] are shown in FIG. 2 and FIG. 3:

As can be seen from FIG. 2, with the begin of the diafiltration the pressure remained on a level of about 15 bar. This is due to the higher sugar concentration of the mother beer which caused fouling. Fouling led to a blocking of the membrane and therefore, in order to keep a constant permeate flux, the pressure increased, which renders the method energy consuming. Nevertheless, as can also be seen from Table 4 below, the dealcoholization was possible. During diafiltration the alcohol was washed out of the retentate with diafiltration water.

### Evaluation of Samples 1 to 4

The alcohol content of Samples 1 to 4 was determined by an enzymatic kit (K-ETOH) available from Megazyme Ltd (Bray, Ireland) using a spectrophotometer to determine the amount of NADH formed in enzymatic reactions using alcohol dehydrogenase and aldehyde dehydrogenase dependent on the amount of ethanol present in the sample. Each sample was measured in triplicate. Average and standard deviations are shown in Table 4 below.

TABLE 4
Ethanol Content

| Sample | Average (% v/v) | Standard deviation |
|---|---|---|
| Sample 1 | 2.05E−01 | 2.38E−03 |
| Sample 2 | 9.59E−03 | 6.87E−05 |
| Sample 3 | 4.97E−02 | 2.99E−04 |
| Sample 4 | 1.03E−02 | 6.87E−05 |

It was found that Sample 2 and Sample 4 had an alcohol content which is below the detection limit for the specific dilution used. Hence, the lowest level detectable for the dilution is specified in Table 4.

Furthermore, Samples 1 to 4 were subjected to a sensory evaluation. The samples were evaluated by a panel for appearance, aroma, flavor, mouthfeel and overall score—with a score of 1 for the lowest and 10 for the highest. The results of this sensory evaluation are shown in Table 5.

TABLE 5

| | Appearance | Aroma | Flavor | Mouthfeel | Overall |
|---|---|---|---|---|---|
| Sample 1 | 7.5 | 7 | 6 | 9 | 8.5 |
| (mother beer) | | | | | |
| Sample 2 | 8 | 5.5 | 7 | 8.5 | 9 |
| (dealcoholized | | | | | |
| beer using | | | | | |
| vacuum | | | | | |
| rectification) | | | | | |
| Sample 3 | 7.5 | 4 | 6.5 | 9 | 6 |
| (dealcoholized | | | | | |
| beer + aroma | | | | | |
| water) | | | | | |
| Sample 4 | 7.5 | 6 | 4 | 6 | 5 |
| (dealcoholized | | | | | |
| beer using | | | | | |
| osmosis) | | | | | |

### Example 2

2.1 Preparation of Low Alcoholic Mother Beer with Maltose-Negative Yeast

140 kg of malt (135 kg Pilsner malt+5 kg Carahell® malt) were mashed at 72° C. for 60 min in 490 L of water supplemented with 98 g of Brewtan B (a 100% natural, high molecular weight tannic acid extracted from renewable plant materials) and mashed out at 78° C. for 5 min. Subsequent to this mashing, the wort was separated from the grist by lautering and sparging. This resulted in about 900 L of wort in the wort kettle which were pH adjusted to pH 5.2 with lactic acid and then boiled for 60 min. 20 min prior to the end of this boiling, 73 g of Brewtan B were added. Furthermore, during the boiling, hops were added to provide bitterness, flavor and aroma. After boiling the wort was transferred to a whirlpool where lactic acid was added to adjust the pH to pH 4.2-4.4. Then, the wort was cooled to 18° C., and aerated while being transferred to the fermentation tank. Defrosted Pichia kluyveri DSM 28484 was added directly to the tank and a circulation loop was started to mix the content of the fermentation tank. The fermentation process was continued until no further change in specific gravity was observed. The obtained mother beer was then cooled to 1-4° C., kept at this temperature and centrifuged and diluted to the same extent as the beer in sample 1 with deaerated brewing water prior to dealcoholization.

### 2.2 Dealcoholization

Six samples were obtained as follows.

### Sample 5:

No further treatment (i.e. mother beer from Example 2.1).

### Sample 6:

The mother beer obtained in Example 2.1 was run through a vacuum rectification process using the DeAlcoTec system from Centec GmbH in the same manner as Sample 2 of Example 1.

### Sample 7:

Commercial non-alcoholic beer 1

### Sample 8:

Commercial non-alcoholic beer 2

### Sample 9:

Commercial non-alcoholic beer 3

### Sample 10:

Commercial non-alcoholic beer 4

The alcohol content of Samples 6 to 10 was determined by an enzymatic kit (K-ETOH) available from Megazyme Ltd. Each sample was measured in triplicate. Average and standard deviation are shown in Table 6 below.

TABLE 6
Ethanol Content

| Sample | Average (% v/v) | Standard deviation |
|---|---|---|
| Sample 5 | 2.17E−01 | 6.87E−04 |
| Sample 6 | 7.72E−03 | 1.24E−04 |
| Sample 7 | 1.80E−02 | 9.62E−04 |
| Sample 8 | 3.31E−03 | 1.01E−04 |
| Sample 9 | 2.94E−02 | 3.63E−04 |
| Sample 10 | 6.89E−03 | 9.09E−05 |

Furthermore, the samples were subjected to a sensory evaluation by a trained sensory panel using the DLG 5-Point Test Scheme from the German Agricultural Society (Deutsche Landwirtschafts-Gesellschaft e.V.) for beer. The criteria of smell, taste, mouthfulness, freshness and bitterness were evaluated by 15 panelists. The criteria were rated using a scale from 1 (lowest; not satisfactory) to 5 (highest; very good). The grade of the beers was calculated using the mean points of the DLG-tasting: Grade=(smell×2+taste×2+mouthfulness×1+freshness×1+bitterness×2)/8. Table 7 shows the average values of the criteria and calculated grade.

TABLE 7

| Sample | Smell | Taste | Mouthfulness | Freshness | Bitterness | Grade |
|---|---|---|---|---|---|---|
| Sample 5 | 4.40 | 4.17 | 4.30 | 3.93 | 4.03 | 4.18 |
| Sample 6 | 4.07 | 4.10 | 4.40 | 4.17 | 4.37 | 4.21 |
| Sample 7 | 3.37 | 3.20 | 3.90 | 3.97 | 3.90 | 3.60 |
| Sample 8 | 3.73 | 3.70 | 4.00 | 3.87 | 4.10 | 3.87 |
| Sample 9 | 4.27 | 4.00 | 4.10 | 3.90 | 3.67 | 3.99 |
| Sample 10 | 4.17 | 3.80 | 4.50 | 4.00 | 4.30 | 4.13 |

Table 7 illustrates that Sample 6 according to the present invention was ranked the highest for taste and freshness compared to other non-alcoholic samples. Sample 6 also obtained the highest grade according to the test scheme.

### Example 3

3.1 Preparation of low alcoholic mother beer with maltose-negative Torulaspora delbrueckii 140 kg of malt (135 kg Pilsner malt+5 kg Carahell® malt) were mashed at 72° C. for 60 min in 490 L of water supplemented with 98 g of Brewtan B (a 100% natural, high molecular weight tannic acid extracted from renewable plant materials) and mashed out at 78° C. for 5 min. Subsequent to this mashing, the wort was separated from the grist by lautering and sparging. This resulted in about 900 L of wort in the wort kettle which were pH adjusted to pH 5.2 with lactic acid and then boiled for 60 min. 20 min prior to the end of this boiling, 73 g of Brewtan B were added. Furthermore, during the boiling, hops were added to provide bitterness, flavor and aroma. After boiling the wort was transferred to a whirlpool where lactic acid was added to adjust the pH to pH 4.2-4.4. Then, the wort was cooled to 18° C., and aerated while being transferred to the fermentation tank. Afterwards, 500 g of active dry yeast Torulaspora delbrueckii (containing more than 5E+09 CFU Torulaspora delbrueckii DSM 33529 in per gram of active dry yeast) were added directly to the tank and a circulation loop was started to mix the content of the fermentation tank. The fermentation process was continued until no further change in specific gravity was observed. The obtained mother beer was then cooled to 1-4° C., kept at this temperature and centrifuged and diluted to the same extent as the beer in sample 1 with deaerated brewing water prior to dealcoholization.

### 3.2 Dealcoholization

Starting from the mother beer obtained in Example 3.1, two different samples were obtained:

### Sample 11:

No further treatment, i.e. identical to the mother beer above described in Example 3.1.

### Sample 12:

The mother beer obtained in Example 3.1 was run through a vacuum rectification process using the DeAlcoTec system from Centec GmbH in the same manner as Sample 2 of Example 1.

### Evaluation of Samples 11 and 12

The alcohol content of Samples 11 and 12 was determined by an enzymatic kit (K-ETOH) available from Megazyme Ltd (Bray, Ireland) using a spectrophotometer to determine the amount of NADH formed in enzymatic reactions using alcohol dehydrogenase and aldehyde dehydrogenase dependent on the amount of ethanol present in the sample. Each sample was measured in triplicate. Average and standard deviations are shown in Table 8 below.

TABLE 8
Ethanol Content

| Sample | Average (% v/v) | Standard deviation |
|---|---|---|
| Sample 11 | 5.15E−01 | 2.38E−03 |
| Sample 12 | 3.43E−03 | 2.75E−05 |

Furthermore, Samples 11 and 12 were subjected to a sensory evaluation. The samples were evaluated by a panel for appearance, aroma, flavor, mouthfeel and overall score-with a score of 1 for the lowest and 10 for the highest. The results of this sensory evaluation are shown in Table 9.

TABLE 9

| | Appearance | Aroma | Flavor | Mouthfeel | Overall |
|---|---|---|---|---|---|
| Sample 11 | 7 | 9 | 9 | 9 | 9 |
| (mother beer) | | | | | |
| Sample 12 | 7 | 6 | 8 | 9 | 8 |
| (dealcoholized | | | | | |
| beer | | | | | |
| using vacuum | | | | | |
| rectification) | | | | | |

Sample 11 was perceived to have a good balance and to closely resembled alcoholic beer of the lager/pilsner type. Furthermore, there was no detectable wort flavor and overall it had a good malt profile and good mouthfeel. Sample 12 was very similar to sample 11 besides a slightly fainter aroma and marginally higher bitterness.

### DEPOSITS

The applicant deposited the Pichia kluyveri DSM 28484 strain on 5 Mar. 2014 at Leibniz Institute DSMZ-German Collection of Microorganisms and Cell Cultures, Inhoffenstr. 7B, D-38124 Braunschweig and received the accession No.: DSM 28484. The applicant deposited the Torulaspora delbrueckii DSM 33529 strain on 27 May 2020 at Leibniz Institute DSMZ-German Collection of Microorganisms and Cell Cultures, Inhoffenstr. 7B, D-38124 Braunschweig and received the accession No.: DSM 33529.

### REFERENCES

### WO 2014/135673

Brányik, T., Silva, D. P., Baszczyňski, M., Lehnert, R., Almeida e Silva, J. B., 2012. A review of methods of low alcohol and alcohol-free beer production. Journal of Food Engineering 108, 493-506.
De Francesco, G., Turchetti, B., Sileoni, V., Marconi, O., Perretti, G., 2015. Screening of new strains of Saccharomycodes ludwigii and Zygosaccharomyces rouxii to produce low-alcohol beer. Institute of Brewing & Distilling, Wiley Online Library 121, 113-121. lorizzo, M., Coppola, F., Letizia, F., Testa, B., Sorrentino E., 2021. Role of Yeasts in the Brewing Process: Tradition and Innovation. MDPI, 9, 839, 1-16.
Jiang, Z., Yang, B., Liu, X., Zhang, S., Shan, J., Liu, J., Wang, X., 2017. A novel approach for the production of a non-alcoholic beer (≤0.5% abv) by a combination of limited fermentation and vacuum distillation. Institute of Brewing & Distilling, Wiley Online Library. 123, 533-536.
Mangindaan, D., Khoiruddin, K., Wenten I. G., 2018. Beverage dealcoholization processes: Past, present, and future. Trends in Food Science & Technology 71, 36-45.
Müller, M., Bellut, K., Tippmann, J., Becker, T., 2017. Physical Methods for Dealcoholization of Beverage Matrices and their Impact on Quality Attributes. Chem BioEng Reviews, Wily Online Library, 4, No. 5, 310-326.
Sohrabvandi, S., Mousavi, S. M., Razavi, S. H., Mortazavian, A. M., Rezaei, K., 2010, Alcohol-free Beer: Methods of Production, Sensorial Defects, and Healthful Effects. Food Review International, 26, 335-352.
Vaštik, P., Šmogrovičová, D., Kafková, V., Sulo P., Furdíková, K., Špánik, I., 2020. Production and characterisation of non-alcoholic beer using special yeast. Research Institute of Brewing and Malting, Plc., 66, 336-344.

1. A method of producing a beverage comprising the steps of:
(a) fermenting a wort using a culture comprising a maltose-negative yeast strain, optionally a non-saccharomyces yeast strain, to obtain a fermented beverage having an alcohol content of less than 1.00% v/v; and
(b) subjecting the fermented beverage to a thermal dealcoholization step at a temperature between 20 to 80° C. to obtain the beverage.

2. The method according to claim 1, wherein the alcohol content of the fermented beverage obtained in step (a) is less than 0.8% v/v, preferably less than 0.6% v/v, more preferably less than 0.5% v/v or less than 0.4% v/v, like 0.2 to 0.3% v/v.

3. The method according to claim 1 or 2, wherein the maltose-negative yeast strain is a sucrose-negative yeast strain, optionally a saccharomyces yeast or a non-saccharomyces yeast.

4. The method according to claim 1, 2 or 3, wherein the maltose-negative yeast strain is selected from the group consisting of strains of Pichia kluyveri, Pichia fermentans, Zygosaccharomyces lentus, Torulaspora delbrueckii, Candida zemplinina, Zygosaccharomyces rouxii, Hanseniaspora valbyensis, Hanseniaspora vineae, Zygosaccharomyces bailii, Zygosaccharomyces kombuchaensis, Kazachstania servazzii, Cyberlindnera mrakii, Cyberlindnera saturnus, Cyberlindnera misumaiensis, Trigonopsis cantarellii, Saccharomyces cerevisiae, Saccharomycodes ludwigii and mixtures thereof.

5. The method according to claim 4, wherein the maltose-negative yeast strain is a Pichia kluyveri strain, wherein preferably the Pichia kluyveri strain is selected from the group consisting of Pichia kluyveri DSM 28484, Pichia kluyveri PK-KR1 (JT1.28), Pichia kluyveri PK-KR2 (JT3.71) and mixtures thereof.

6. The method according to any of the preceding claims, wherein the thermal dealcoholization in step (b) is performed at a temperature of 20 to 60° C., preferably 20 to 50° C., more preferably 20 to 40° C., and most preferably 25 to 35° C.

7. The method according to any of the preceding claims, wherein the thermal dealcoholization in step (b) is performed in a vacuum rectification column, a thin film evaporator, a stripping column or a spinning cone column.

8. The method according to any of the preceding claims, wherein the thermal dealcoholization in step (b) is performed at a pressure of less than 40 kPa, preferably less than 20 kPa, more preferably less than 10 kPa, such as 1 to 5 kPa.

9. The method according to any of the preceding claims, wherein the thermal dealcoholization in step (b) is vacuum stripping or vacuum rectification, wherein preferably the vacuum rectification is performed in a vessel having a first end and a second end, wherein the fermented beverage obtained in step (a) is fed into the vessel in form of a liquid at the first end and a vapor stream is fed into the vessel at the second end, wherein the vapor flows through the vessel in countercurrent to the liquid fermented beverage and the vapor contacts the fermented beverage.

10. The method according to claim 9, wherein the thermal dealcoholization in step (b) is performed at a vapor flow rate of 5 to 50 kg·h⁻¹, preferably 15 to 45 kg·h⁻¹, more preferably 20 to 45 kg·h⁻¹, such as 25 to 40 kg·h⁻¹ or 30 to 40 kg·h⁻¹.

11. The method according to claim 9 or 10, wherein the thermal dealcoholization in step (b) is performed at a vapor back-pressure of 50 to 350 kPa, preferably 200 to 350 kPa, more preferably 250 to 350 kPa.

12. The method according to any of the preceding claims, wherein the beverage obtained in step (b) has an alcohol content of less than 0.5% v/v, preferably less than 0.1% v/v, more preferably less than 0.05% v/v, like 0.000 to 0.030% % v/v or 0.000 to 0.020% v/v or 0.000 to 0.010% v/v.

13. The method according to any of the preceding claims, wherein the beverage is a beer, preferably an alcohol-free beer.

14. A beverage obtained or obtainable by the method according to any of the preceding claims, comprising said maltose-negative yeast strains.

15. Use of a maltose-negative yeast strain for producing a beverage which includes the steps of:
(a) fermenting a wort using a culture comprising the maltose-negative yeast strain to obtain a fermented beverage having an alcohol content of less than 1.00% v/v; and
(b) subjecting the fermented beverage to a thermal dealcoholization step at a temperature between 20 to 80° C. to obtain the beverage.
